(19) United States
(12) Patent Application Publication
(10) Pub. No.: US 2007/0160433 A1
(43) Pub. Date: Jul. 12, 2007

(54) CUTTING INSERT

(76) Inventors: Sang-Soo Lee, Dangjin (KR); Hyung-Keun Joo, Cheong-Ju City (KR); Wook-Jung Sung, Chung-Won Gun (KR)

Correspondence Address: IPLA P.A., 3580 WILSHIRE BLVD., 17TH FLOOR, LOS ANGELES, CA, 90010, US

(21) Appl. No.: 11/617,571

(22) Filed: Dec. 28, 2006

(30) Foreign Application Priority Data
Jan. 2, 2006 (KR) 10-2006-0000016

(51) Int. Cl. B23P 15/28

(52) U.S. Cl. 407/113; 407/115

(57) ABSTRACT

A cutting insert is disclosed, where the shape of a cutting edge is improved so that the minimum cutting load is applied during a cutting process to obtain the same surface roughness although the cutting insert is fed at high speed and to thus obtain high efficiency and high productivity. The diamond-shaped cutting insert includes an upper part and a lower part, a top surface and a bottom surface that are lower than the upper part and higher than the lower part, respectively, side parts for connecting the top surface to the bottom surface, corner parts for smoothly connecting the side parts to each other, a cutting edge formed by crossing the top surface, the bottom surface, the side parts, and the corner parts, and a chip breaker formed from the cutting edge to between the top surface and the bottom surface.

### CROSS-REFERENCE

Applicant claims the benefit of Korean Patent Application No. 10-2006-0000016, filed on Jan. 02, 2006, in the Korean Intellectual Property Office, the disclosure of which is incorporated herein by reference.

### BACKGROUND OF THE INVENTION

1. Field of the Invention

The present invention relates to a cutting insert, and more particularly, to a cutting insert in which the shape of a cutting edge is improved so that the minimum cutting load is applied during a cutting process to obtain the same surface roughness although the cutting insert is fed at high speed and to thus obtain high efficiency and high productivity.

2. Description of the Related Art

A cutting tool is commonly used for cutting ferrous metals, nonferrous metals and nonmetallic material and is mainly mounted in a machine tool to make a work piece have desired shape. The cutting tool is commonly composed of a cutting insert with a cutting edge and a shank holding the cutting insert.

Additionally, there are two methods of cutting metal with cutting tool. The one is to contact the cutting edge of the fixed cutting tool on a rotating work piece and to thus cut the work piece. The other is to contact the rotating tool on a fixed work piece after mounting the cutting insert with a holder on a machine tool and to thus make the work piece have a desired shape.

The turning belongs to the former of the above metal cutting methods and refers to cutting a work piece to the desired shape with the feed movement of the cutting tool on the plane including the rotation and the rotating axis of the work piece. The turning is widely used because it is possible to effectively cut many kinds of work pieces according to the feed movement of the cutting tool based on the type of the work piece.

The requirements of the cutting insert for the turning are as follows:

First, the cutting insert needs to effectively remove cutting chips that are continuously ejected, which is not avoidable due to the characteristic of the turning.

Second, the cutting insert needs to have a long service life. The service life depends on the following factors: frictional wear from a work piece and cutting mechanism, chemical abrasion from the heat generation, impact wear from the vibration of a tool and work piece, and impact damage etc. They closely relate to the cutting resistance in the cutting mechanism.

Third, better surface roughness should be obtained after the cutting process. When the cutting conditions for improving the surface roughness are set up, the service life of the tool is reduced and the cutting time increases so that productivity deteriorates.

Recently, the need of improving the productivity during the cutting process increases. It can be satisfied by high speed cutting and high feed rate (or high table feed rate) cutting. However, the high speed cutting is very limited due to wearing tool and deteriorating machine preciseness so that it is difficult to commonly apply the high speed cutting. Also, since the surface roughness deteriorates, the high feed rate cutting should be applied to conditions where the surface roughness is not important.

In general, in the turning, the feed amount usually refers to a distance by which a tool is fed in the machining direction per one revolution of a work piece. The larger the feed amount is the shorter the cutting time is so that it is possible to improve the productivity. A commonly applied feed amount is approximately 0.2-0.3 mm per one revolution of a work piece and the use of a conventional cutting insert does not affect the surface roughness.

However, the desired work piece preciseness and target quality cannot be obtained because post-cutting surface roughness rapidly deteriorates under high feed rate (approximately 0.4-0.6 mm/revolution). Therefore, it is difficult to increase productivity by using high feed rate and thus shortening the cutting time.

The cutting insert for turning has been developed in order to prevent the surface roughness problem from occurring in high feed cutting.

Such cutting inserts were disclosed in U.S. Pat. Nos. 5,226,761 and 5,634,745. However, those products make good surface roughness with high feed condition but produce more cutting resistance in cutting and the cutting surface get more tough and vibration with normal and low feed condition as well as there are problems with an abrasion and damage of the cutting insert.

Those problems occur because the curvature radius of the corner cutting edge (of cutting insert that touches and feeds on the surface of a work piece and determines the surface roughness) is excessively large or the clearance angle of the straight-line cutting edge is too small so that the friction area of a work piece and a tool increases.

That is, bending force is applied to a holder because a cutting resistance on the corner cutting edge is greater than the feed force under normal conditions; a vibration is caused by radial force on insert holder. Additionally, considerable load is applied to a work piece during a cutting process and then problem with uneven surface roughness occurs because contact surface of the corner cutting edge and a work piece is increased due to cutting resistance increment under high feed rate condition.

### SUMMARY OF THE INVENTION

The present invention has been made in view of the above-mentioned problems, and an aspect of the invention is to provide a cutting insert in which the shape of a cutting edge is improved so that the minimum cutting load is applied during a cutting process so that it is possible to obtain the same surface roughness although the cutting insert is fed at high speed and to thus obtain high efficiency and high productivity.

In accordance with one aspect, the present invention provides a diamond-shaped cutting insert including an upper part and a lower part, a top surface and a bottom surface that are lower than the upper part and higher than the lower part, respectively, side parts for connecting the top surface to the bottom surface, corner parts for smoothly connecting the side parts to each other, a cutting edge formed by crossing the top surface, the bottom surface, the side parts, and the corner parts, and a chip breaker formed from the cutting edge to between the top surface and the bottom surface. The cutting edge also includes corner cutting edges formed by crossing the corner pars, the top surface, and the bottom surface, side cutting edges formed by crossing the side parts, the top surface, and the bottom surface, and wiper cutting edges adjacent to both sides of the corner cutting edge at an acute angle. The wiper cutting edge includes a first sub-cutting edge straight-lined from both sides of the corner cutting edge and a second sub-cutting edge curve-lined to the outside of the side part and extended from the extension end of the first sub-cutting edge to the side cutting edge adjacent to the extension end of the first sub-cutting edge when viewing the cutting insert at a level surface.

As described above, according to the present invention, the shape of a cutting edge is improved so that the minimum cutting load is applied during a cutting process so that it is possible to obtain the same surface roughness although the cutting insert is fed at high speed and to thus obtain high efficiency and high productivity.

### BRIEF DESCRIPTION OF THE DRAWINGS

These and/or other aspects and advantages of the invention will become apparent and more readily appreciated from the following description of the embodiment, taken in conjunction with the accompanying drawings in which:

FIG. 1 is a perspective view illustrating a cutting insert according to the present invention;

FIG. 2 is a plan view of the cutting insert illustrated in FIG. 1;

FIG. 3 is a front view illustrating only a part of the cutting insert illustrated in FIG. 1;

FIG. 4 illustrates the enlargement of the part “A” of FIG. 1;

FIG. 5 is a sectional view taken along the line B-B of FIG. 1; and

FIG. 6 illustrates a state in which the cutting insert illustrated in FIG. 1 is mounted in a tool holder.

### DETAILED DESCRIPTION OF THE PREFERRED EMBODIMENTS

A cutting insert having wiper cutting edges according to an embodiment of the present invention will be described with reference to the attached drawings.

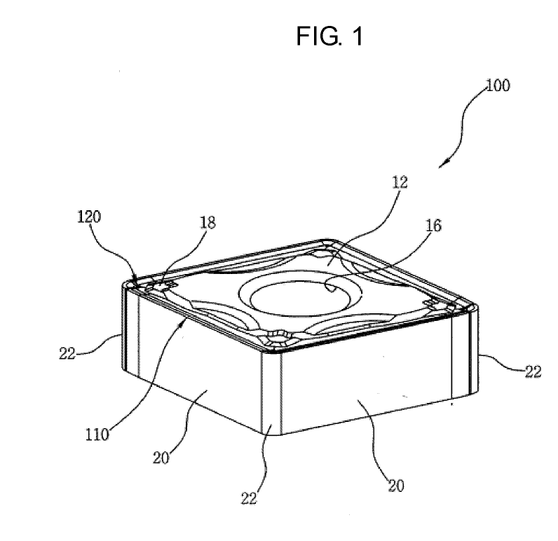

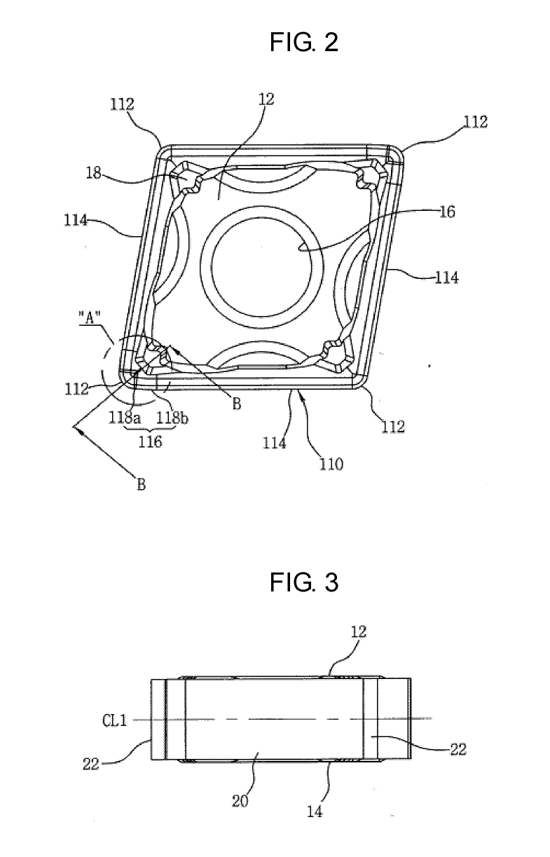

FIG. 1 is a perspective view illustrating a cutting insert according to the present invention. FIG. 2 is a plan view of the cutting insert illustrated in FIG. 1. FIG. 3 is a front view illustrating only a part of the cutting insert illustrated in FIG. 1.

As illustrated in the drawings, the cutting insert (100) according to the present invention is mainly made of cemented carbide alloy through powder metallurgy with embossing, sintering, and grinding.

As described above, the diamond-shaped cutting insert (100) includes an upper part 12, a lower part 14, and a circular opening 16 that passes through the centers of the upper part 12 and the lower part 14. Additionally, the cutting insert 100 includes a top surface 18 and a bottom surface (not shown) that are lower than the upper part 12 and higher than the lower part 14, respectively, side parts 20 for connecting the top surface 18 to the bottom surface (not shown), corner parts 22 for smoothly connecting the side parts 20 to each other, a cutting edge 110 formed by crossing the top surface 18, the bottom surface, the side parts 20, and the corner parts 22, and a chip breaker 120 formed from the cutting edge 110 to between the top surface 18 and the bottom surface. Either the upper part 12 or the lower part 14 of the cutting insert 100 can be selectively used for cutting ferrous metals and nonferrous metals. The upper part 12 and the lower part 14 are symmetrical with each other based on a virtual central line CL1 that vertically bisects the side parts 20.

The cutting edge 110 includes corner cutting edges 112 formed by crossing the corner parts 22, the top surface 18, and the bottom surface, side cutting edges 114 formed by crossing side parts 20, the top surface 18, and the bottom surface, and wiper cutting edges 116 adjacent to both sides of the corner cutting edge 112 at an acute angle. Preferably, the corner cutting edges 112, the wiper cutting edges 116, and the side cutting edges 114 have altogether the same height.

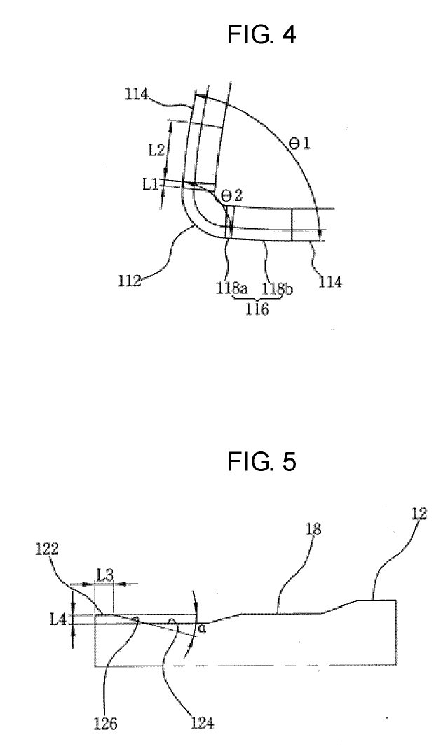

FIG. 4 illustrates the enlargement of the part “A” of FIG. 1.

The wiper cutting edge 116 includes a first sub-cutting edge 118a straight-lined from both sides of the corner cutting edge 112 and a second sub-cutting edge 118b curve-lined and extended from the extension end of the first sub-cutting edge 118a to the side cutting edge 114 adjacent to the extension end of the first sub-cutting edge 118a. In this case, each side cutting edge 114 adjacent to any corner cutting edge 112 at an acute angle has θ1=80° with corner cutting edge 112 as a center.

Meanwhile, the first sub-cutting edge 118a has θ2=86° with the corner cutting edge 112 as a center, and the length L1 of the first sub-cutting edge 118a is 0.05-0.2 mm from the extension end of the corner cutting edge 112. Also, when viewing the cutting insert 100 at the level surface, the length L2 of the second sub-cutting edge 118b is 0.4-3.2 mm from the extension end of the first sub-cutting edge 118a as well as the second sub-cutting edge 118b protrudes to the outside of the side part 22 with the radius of 5-25 mm.

FIG. 5 is a sectional view taken along the line B-B of FIG. 1.

Referring to the drawing 5, the chip breaker 120 exists between the cutting edge 110 and the upper part 12, that is, exists on the top surface 18. The chip breaker 120 includes a land 122 that extends from the cutting edge 110 to top surface 18 and the chip breaking groove 124 that is concavely formed on the extension end of the land 122. The length of land 122 is 0.2 mm from the cutting edge 110 and the length of the chip breaking groove 124 is 0.1 mm L4 that is smaller than the height of the cutting edge 110 by 0.1 mm as well as there is the chip breaking inclination 126 between the extension end of land 122 and the chip breaking groove 124. The angle α of the chip breaking inclination 126 is 12-17° with a down slope from the land 122 and preferably 15° is provided.

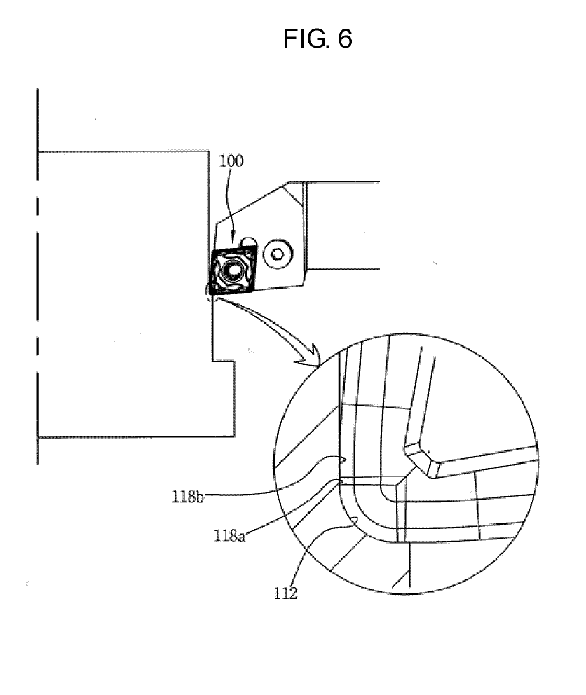

FIG. 6 illustrates a state in which the cutting insert illustrated in FIG. 1 is mounted in a tool holder. Referring to FIG. 6, in the cutting insert 100 according to the present invention, the distance between the straight-line L of the first sub-cutting edge 118a connected to the corner cutting edge 112 and a work piece is 0.001-0.004 mm and the distance between the straight-line of the first sub-cutting edge 118a and the second sub-cutting edge 118b is 0.002-0.041 mm. The distances between the first sub-cutting edge 118a and the second sub-cutting edge 118b and the work piece determines the surface roughness.

Thus formed cutting insert 100 includes the first sub-cutting edge 118a of straight-line and the second sub-cutting edge 118b of curve-line so that it is possible to improve the surface roughness under high feed rate condition, 0.5 mm (f=0.5 mm/rev).

As described in the above, the cutting insert 100 according to the present invention includes the wiper cutting edge 116 having the straight-lined first sub-cutting edge 118a adjacent to the corner cutting edge 112 at an acute angle and the curve-lined second sub-cutting edge 118b extended from the first sub-cutting edge 118a so that excellent surface roughness can be obtained as well as the productivity can be maximized without increasing cutting resistance or shortening a tool service life.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A diamond-shaped cutting insert comprising an upper part and a lower part, a top surface and a bottom surface that are lower than the upper part and higher than the lower part, respectively, side parts for connecting the top surface to the bottom surface, corner parts for smoothly connecting the side parts to each other, a cutting edge formed by crossing the top surface, the bottom surface, the side parts, and the corner parts, and a chip breaker formed from the cutting edge to between the top surface and the bottom surface,
wherein the cutting edge also comprises corner cutting edges formed by crossing the corner pars, the top surface, and the bottom surface, side cutting edges formed by crossing the side parts, the top surface, and the bottom surface, and wiper cutting edges adjacent to both sides of the corner cutting edge at an acute angle, and
wherein the wiper cutting edge comprises a first sub-cutting edge straight-lined from both sides of the corner cutting edge and a second sub-cutting edge curve-lined to the outside of the side part and extended from the extension end of the first sub-cutting edge to the side cutting edge adjacent to the extension end of the first sub-cutting edge when viewing the cutting insert at a level surface.

2. The cutting insert as claimed in claim 1, wherein the corner cutting edge, the wiper cutting edge, and the side cutting edge have same height.

3. The cutting insert as claimed in claim 1, wherein the side cutting edges adjacent to any one of the corner cutting edges at an acute angle has 80° of the angle with the corner cutting edge as a center.

4. The cutting insert as claimed in claim 1,
wherein the first sub-cutting edge comprises 86° of the angle with the corner cutting edge as a center and the length of the first sub-cutting edge is 0.05-0.2 mm from the extension end of the corner cutting edge, and
wherein the length of the secondary sub-cutting edge is 0.4-3.2 mm from the extension end of the first sub-cutting edge as well as the second sub-cutting edge is protruded to outside of the side part with a radius of 5-25 mm.

5. The cutting insert as claimed in claim 1,
wherein the chip breaker exists on the top of the cutting edge,
wherein the chip breaker comprises a land that extends from the cutting edge to the top surface and a chip breaking groove that is concavely formed on the extension end of the land,
wherein the length of land is 0.2 mm from the cutting edge,
wherein the chip breaking groove is 0.1 mm lower than the height of the cutting edge as well as there is a chip breaking inclination between the extension end of the land and the chip breaking groove, and
wherein the angle of the chip breaking inclination is 12-17° with a down slope from land.
